(19) United States
(12) Patent Application Publication
(10) Pub. No.: US 2025/0249454 A1
(43) Pub. Date: Aug. 7, 2025

(54) CONTROLLING AND MANIPULATING FLOATING DROPLETS

(71) Applicant: The Trustees of Princeton University, Princeton, NJ (US)

(72) Inventors: Paul R. Kaneelil, Princeton, NJ (US); Howard A. Stone, Princeton, NJ (US); Amir A. Pahlavan, Hamden, CT (US); J. Pedro de Souza, Princeton, NJ (US); Günther Turk, Princeton, NJ (US)

(73) Assignee: The Trustees of Princeton University, Princeton, NJ (US)

(21) Appl. No.: 19/048,265

(22) Filed: Feb. 7, 2025

Related U.S. Application Data
(60) Provisional application No. 63/550,669, filed on Feb. 7, 2024.

(51) Int. Cl. B01L 3/00

(52) U.S. Cl. CPC B01L 3/50273; B01L 2200/0673; B01L 2400/02; B01L 2400/0415

(57) ABSTRACT

Disclosed is a method to control and manipulate floating water droplets. More particularly, disclosed are the self-assembly and pattern formation of electrically charged water droplets that are floating at an oil-gas interface. Also shown is that the assembly occurs because of electrostatic interactions between the drops. It is shown that the depth of the oil bath plays a significant role in the distance between the drops assembled at the interface. The relevance of the type of the boundary containing the entire system is highlighted by showing that even drops with a net zero electric charge can self-assemble under certain conditions. Furthermore, disclosed are ways to control the motion and the assembly of the drops at an interface.

### CROSS-REFERENCE TO RELATED APPLICATIONS

The present application claims priority to U.S. Provisional Patent Application No. 63/550,669, Filed Feb. 7, 2024, which is incorporated by reference herein by its entirety.

### TECHNICAL FIELD

The present application is drawn to apparatus, systems, and methods for controlling and manipulating floating droplets, such as floating water droplets.

### BACKGROUND

This section is intended to introduce the reader to various aspects of the art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Controlling and manipulating drops is crucial for several applications including biological testing, cell-based screening, and controlled chemical reactions. Conventional technologies that currently use electric effects to manipulate drops on a surface require sophisticated electrode designs and equipment to produce dangerously high voltages to apply external electric fields. Some also require cleanroom equipment and intricate surface modification procedures.

### BRIEF SUMMARY

Various deficiencies in the prior art are addressed below by the disclosed systems, methods, and apparatus configured for controlling and manipulating droplets.

In various aspects, a system may be provided. The system may include a container, an anhydrous composition within the container, and a droplet at the upper surface (e.g., at an oil-gas interface, such as an oil-air interface). The anhydrous composition may include an oil, and the droplet may include an aqueous composition. The anhydrous composition may be disposed within the container such that a surface of the anhydrous composition is exposed to a gas (such as air) to form an oil-gas interface. A bottom internal surface of the container may be in contact with the anhydrous composition.

Different configurations of the containers and droplets may be utilized. In a first configuration, the droplet may be neutrally charged and the container may be an insulated container. In a second configuration, the droplet may be electrically charged and the container may be a grounded, conductive container.

In some aspects, the droplet may include four or more droplets, and an average distance between each droplet and the at least three closest droplets is configured to be controlled by adjusting an average depth of the anhydrous composition within the container.

The bottom internal surface of the container may be flat, such that a depth of the anhydrous composition in the container is substantially constant. Alternatively, the bottom internal surface of the container may be contoured, such that a depth of the anhydrous composition at a first location within the container is less than a depth of the anhydrous composition at a second location within the container.

The system may include a stylus having an electrostatic charge on at least one surface. The at least one surface may be configured to polarize the droplet while being disposed a distance from the droplet. The at least one surface may be configured to allow the droplet to be repositioned when the stylus is moved parallel to the oil-gas interface. The stylus may be configured to be held above the oil-gas interface when moving parallel to the oil-gas interface.

The oil may include, e.g., a plurality of oils. The anhydrous composition may include, e.g., a non-conductive fluid. The anhydrous composition and/or the aqueous composition may include a surfactant. In some arrangements, the anhydrous composition and the aqueous composition may be free of surfactants.

In various aspects, a kit may be provided. The kit may include a container and a dispensing nozzle. Different configurations of the containers and dispensing nozzles may be utilized. In a first configuration, the container may be an insulated container and the dispensing nozzle may be a conductive dispensing nozzle. In a second configuration, the container may be a grounded, conductive container and the dispensing nozzle may be an insulated dispensing nozzle. In certain aspects, a bottom internal surface of the container may be flat, or may be contoured such that an internal volume of the container has at least a first portion with a smaller depth than a second portion.

The kit may include a stylus capable of having an electrostatic charge on at least one surface. That surface may be configured to polarize the droplet while being disposed a distance from the droplet, and may allow the droplet to be repositioned when the stylus is moved parallel to the oil-gas interface.

In various aspects, a method for controlling droplets at an oil-gas interface may be provided. The method may include providing either (i) neutrally charged aqueous droplets at the oil-gas interface within an insulated container, or (ii) electrically charged aqueous droplets at the oil-gas interface with a grounded, conductive container. The method may include controlling droplets without contacting the droplets using at least one technique. A first technique for contactless control may be to actively repositioning droplets by moving a stylus having an electrostatic charge on at least one surface over the oil-gas interface to polarize the droplet and allowing the droplet, after being polarized, to be repositioned as the stylus moves. A second technique for contactless control may be passively repositioning droplets by allowing electrically charged aqueous droplets to interact with a contoured bottom internal surface of the grounded, conductive container, to preferentially move towards a location having a smaller distance between the bottom internal surface and the oil-gas interface. In some instances, a combination of these two techniques may be used.

### BRIEF DESCRIPTION OF THE FIGURES

The accompanying drawings, which are incorporated in and constitute a part of this specification, illustrate embodiments of the present disclosure and, together with a general description of the present disclosure given above and the detailed description of the embodiments given below, serve to explain the principles of the present disclosure.

FIG. 1 is an illustration of a cross-sectional view of an embodiment of a system (e.g., a first configuration as disclosed herein).

FIG. 2 is a top view experimental image showing preferential self-assembly of droplets in a system such as that shown in FIG. 1; scale bar represents 1.0 cm.

FIG. 3 is an illustration of a cross-sectional view of another embodiment of a system (e.g., a second configuration as disclosed herein).

FIG. 4 is a top view experimental image showing preferential self-assembly of charged droplets in a system such as that shown in FIG. 3; scale bar represents 1.0 cm.

FIG. 5 is an illustration showing a zoomed in cross-sectional view of an example of preferential assembly of polarized but uncharged droplets, where the container is covered with aluminum foil with only a small window in the middle cut out to expose the dielectric material of the container, with the inset showing a schematic of the drops polarized, in this case, by a negative charge on the container surface below.

FIGS. 6A-6E are experimental images showing drops assembled near the static charge that are present on the dielectric surface; note that the interior of the dotted circle represents the area that is exposed to the dielectric material underneath. The assembled drops of N=2 (6A), N=3 (6B), N=4 (6C), N=5 (6D), N=5 (6E) show 2D crystalline order. Scale bars represent 1.0 cm.

FIG. 7 is an experimental image showing an “unorganized” state where the entire dielectric surface of the container is exposed. Drops that had been dyed with different colors are randomly dispensed over the surface and get attracted by nearby charges.

FIG. 8 is an experimental image showing an “organized” state, where three windows expose the dielectric surface of the container. Drops are dispensed such that each window collects a different colored drop. Scale bars represent 1.0 cm.

FIGS. 9A-9C are images showing the distance between drops over time, for a. case where h=0.4 cm at the moment the assembly was allowed to relax or spread out, where t=0 seconds (9A), t≈26 seconds (9B), and t≈60 seconds (9C), where the tails map out the trajectory of each drop and the scale bars represent 1 cm.

FIG. 10 is a plot showing the time evolution of the average distance d between the drops for several h values, as the drop assembly relaxes and reaches a quasi-equilibrium configuration with d_{eq}.

FIG. 11 is a plot based on the data in FIG. 10, where rescaling the data by subtracting away the initial distance d(t=0)=dᵢ, collapses the curves; Here, t_{c}=(d_{eq}−dᵢ)/V₀ and V₀ is the initial velocity of the drops.

FIG. 12 is a plot showing the quasi-equilibrium distance d_{eq} as a function of h in various experiments.

FIG. 13 is a schematic illustration showing the geometry considered in the theoretical model. The drop is represented as a flat circle of radius R which is at a distance h from the bottom conductive boundary.

FIG. 14 is a plot showing an exact electrostatic potential ϕ (dashed line) and the approximate solution ϕₘ (eqn (1); solid line) at the interface, z=0, in the point charge limit (R→∞).

FIG. 15 is a plot showing the ratio of the magnitude of the theoretical velocity of the drop to the magnitude of the experimentally measured velocity, [symbol] V/Vₑₓₚ [symbol] , plotted as a function of time.

FIG. 16 is a plot showing the dimensionless total energy represented by Eq. 4 with A=0.1, 0.5, and 1, and B=7.

FIG. 17 is a schematic illustration showing a system similar to that of FIG. 1, with polarized but uncharged drops, where the polarization comes from static charges on the surface of a dielectric stylus.

FIG. 18 is an image showing the spatiotemporal evolution of a drop as a stylus is used to write out the letter “P” with the drop. The time elapsed was 45 seconds. The scale bar represents 1 cm.

FIG. 19 is an image showing another spatiotemporal evolution of a drop as a stylus is used to make a sine wave. The time elapsed was 15 seconds. The scale bar represents 1 cm.

FIG. 20 is a schematic illustration showing a cross-section of a containing having a hemispherical cylinder on the bottom to create a non-uniform surface.

FIG. 21 is a top-down image showing drops preferentially assembled and aligned over the ridge of the hemispherical cylinder. The horizontal feature on the image correspond to the elevated bottom surface. The scale bar represents 1 cm.

FIG. 22 is a schematic illustration showing a cross-section of a geometry considered in an experiment, where an inclined plane with an angle of about 2° is placed below the drop.

FIG. 23 is a spatiotemporal image showing the trajectory of the spontaneous motion of a charged drop over the inclined plane. The time elapsed was 48 seconds. The scale bar represents 1 cm.

It should be understood that the appended drawings are not necessarily to scale, presenting a somewhat simplified representation of various features illustrative of the basic principles of the present disclosure. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the present disclosure. It will thus be appreciated that those skilled in the art will be able to device various arrangements that, although not explicitly described or shown herein, embody the principles of the present disclosure and are included within its scope. Furthermore, all examples recited herein are principally intended expressly to be only for illustrative purposes to aid the reader in understanding the principles of the present disclosure and the concepts contributed by the inventor to furthering the art and are to be construed as being without limitation to such specifically recited examples and conditions. Additionally, the term, “or”, as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claims. Moreover, some statements may apply to some inventive features but not to others. Those skilled in the art and informed by the teachings herein will realize that the present disclosure is also applicable to various other technical areas or embodiments.

From the beautiful organization of swarming birds to the growth of molecular crystals, self-assembly occurs all around us at a wide range of length scales. Disclosed herein are the self-assembly and pattern formation of electrically charged droplets, such as water droplets that are floating at an oil-air interface. Also shown is that the assembly occurs because of electrostatic interactions between the drops. Using experiments and theory, it can be shown that the depth of the oil bath plays a significant role in the distance between the drops assembled at the interface. The relevance of the type of the boundary containing the entire system is highlighted by showing that even drops with a net zero electric charge can self-assemble under certain conditions.

Furthermore, disclosed are ways to control the motion and the assembly of the drops at an interface without the need for sophisticated electrode designs to apply external electric fields, or intricate surface modification procedures. The approach disclosed herein can be used, inter alia, to create controlled and localized assemblies of floating drops at an oil-air interface. The system can be designed to make drops “lock” onto certain spots on the interface such that they are not freely floating around. The disclosed approach can also be used to manipulate floating drops at the interface in a desired fashion. The drops can be actively controlled using a stylus and passively controlled by modifying the height profile of the bottom surface of the container. Both methods allow for the manipulation and movement of drops along the interface without direct contact with the drop.

Controlling and manipulating drops is crucial for several applications including biological testing, cell-based screening, and controlled chemical reactions. The disclosed approach will also prove useful for any drop-microfluidics type applications as well.

The disclosed approach is understood to be the first that shows how to manipulate and control drops that are floating at an oil-air interface. Several other methods have been proposed before to control drops that are sitting on a surface and even drops and particles in bulk liquid. The floating drop configuration allows the system to be isolated from the environment in the sense that the reagents that need to be placed in the drops will not be contaminated via contact with any surfaces. Since the fluorinated oil that the drops are floating on is biocompatible, the reagents can be truly isolated from its environment.

The disclosed methods do not require expensive equipment or elaborate preparations. Because of the employment of electrostatic interactions for the disclosed methods, background electrical fields in the environment may unintentionally affect the dynamics of the floating drops. This can be overcome by using a Faraday cage to isolate the system. Other factors such as humidity can also play a role in weakening the electrostatic effects. An environmental chamber or active humidity-controlled rooms can help overcome this.

The disclosed process could be used, inter alia, as part of biomanufacturing or biological research to create isolated cell-based assays that are floating and therefore unable to contact surfaces. The disclosed methods could also be leveraged to create autonomous and directed motion of charged drops along an interface which might have applications in sorting drops that contain a particular charged specimen. The disclosed process can potentially be used to fabricate several new devices.

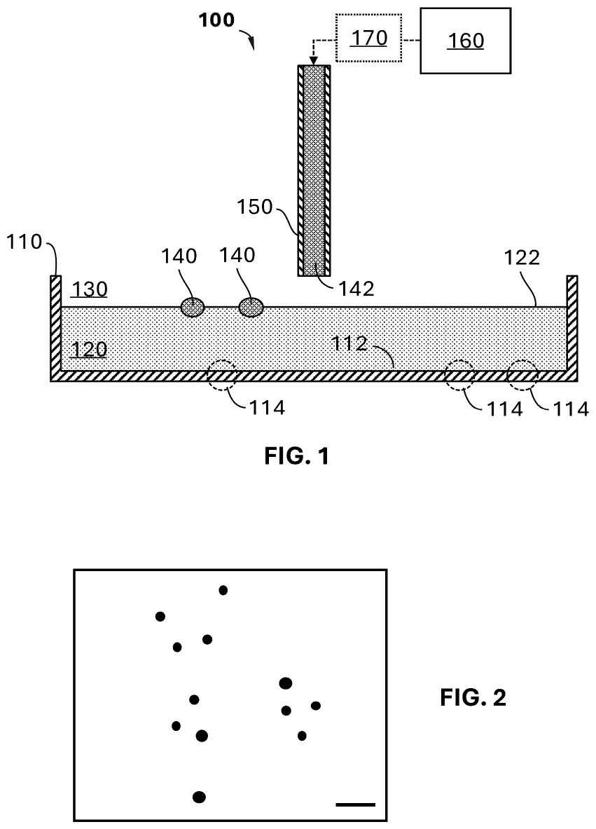

In various aspects, a system may be provided. Referring to FIG. 1, the system (100) may include a container (110), an anhydrous composition (120) within the container, and one or more droplets (140) at the upper surface (122) of the anhydrous composition. The upper surface of the anhydrous composition may be exposed to a gas, such as air, nitrogen, CO₂, etc. The upper surface will therefore be understood as being an oil-gas interface, such as an oil-air interface. The external environment (130) above the anhydrous composition may be any appropriate environment.

The anhydrous composition may include, e.g., a non-conductive fluid. The anhydrous composition may include one or more oils. In some embodiments, a single oil is utilized. In some embodiments, a plurality of oils is utilized. An oil is generally understood as a viscous liquid substance that is typically hydrophobic (i.e., does not mix with water) and lipophilic (i.e., mixes with other oils). Typically, the anhydrous composition will be added to the container, such that the anhydrous composition fills only a portion of the internal volume of space defined by the container. A bottom internal surface (112) of the container (110) may be in contact with the anhydrous composition.

The anhydrous composition should have a density greater than that of the aqueous composition. The anhydrous composition should have a density greater than that the density of water. Preferably, the anhydrous composition may have a density of at least 1250 kg/m³.

The anhydrous composition should have a low relative permittivity (∈ᵣ). In preferred embodiments, the relative permittivity is less than 5, less than 4.5, less than 4, or less than 3.5. Preferably, the relative permittivity is no more than 3, more preferably no more than 2.75, still more preferably less than 2.5, even more preferably less than 2.25, and most preferably less than 2.

The droplet may include an aqueous composition. The droplet may preferably include water.

The anhydrous composition and/or the aqueous composition may include a surfactant. In some arrangements, the anhydrous composition and the aqueous composition may be free of surfactants.

Different configurations of the containers and droplets may be utilized.

In a first configuration, the one or more droplets (140) may be neutrally charged and the container (110) may be an insulated container. The droplets are shown as being dispensed from a nozzle (150), which may be, e.g., a metal needle. The nozzle is operably coupled to a source (160) of the aqueous composition. In one embodiment, this may be, e.g., a syringe coupled to the metal needle. In other embodiments, other components (such as a pump (170)) may be used to move the aqueous composition from a reservoir to the nozzle. As will be understood, there are numerous known techniques for providing a controlled flow of droplets through a nozzle; any appropriate technique may be utilized. The drops, which have a neutral charge, float at the oil-gas interface and the container is an insulator (dielectric). The container may have localized static charges (114) on the dielectric.

### Example 1

FLUORINERT® Electronic Liquid FC-40 (Sigma-Aldrich) is used as the oil forming the anhydrous composition. It has a relative permittivity of ∈ᵣ=1.9, surface tension γ₀==17.3±0.3 mN/m, viscosity μ₀=4.01 mPa·s, and a density of ρ₀=1855 kg/m³. These two properties are crucial for all observations presented here: a low relative permittivity allows for electrostatic interactions through the oil without screening, and a high density allows for the water drops to float on top. NOVEC™ 7500 Engineered Fluid (3M) was tried with ∈ᵣ=5.8 as the oil phase and did not observe self-assembly. In this example, the aqueous phase is deionized water dyed with Erioglaucine disodium salt (0.4 wt. %; Sigma-Aldrich).

The water drops are not charged and are dispensed onto a petri dish (150 mm) that is an insulator (dielectric). The uncharged drops can still be polarized by static charges on the surface of the container, or any nearby objects, and therefore can be assembled and controlled at the oil-air interface. Referring to FIG. 1, the aqueous phase is dispensed continuously from a syringe through a conductor (metal needle) to ensure neutral charge, and are allowed to fall onto the oil bath. FIG. 2 shows a top view of the drops self-assembled at the interface in this example.

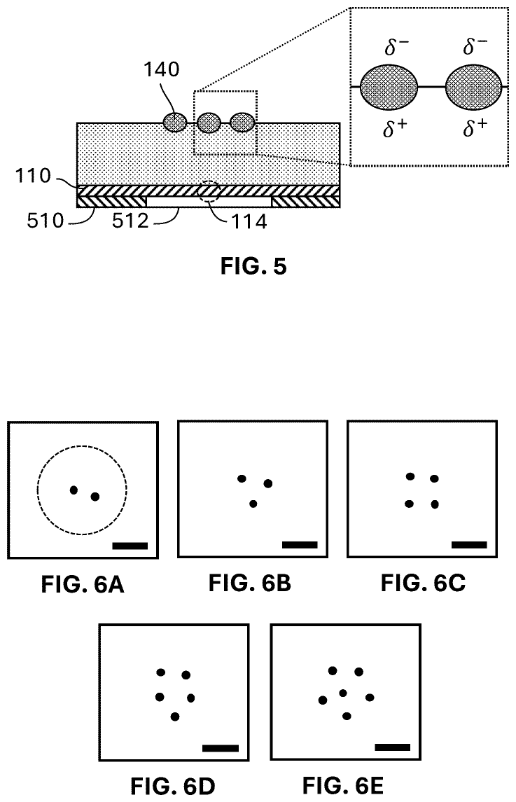

It is very common for static charges to be present on dielectric surfaces; some consequences of this include hair sticking to a comb or furry animals covered in packing peanuts. FIG. 5 shows a schematic of an example oil-water system in a petri dish (e.g., container (110)) covered with aluminum foil (510) with a small circular window (512) cut out in the middle. The small circular window exposes the plastic underneath, which is a dielectric surface prone to static charges. In fact, one can, to some extent, place charges on dielectric surfaces by bringing two dielectric surfaces into contact, causing a charge separation that leaves one surface with an excess negative and the other with an excess positive charge. In various examples herein, this was done by touching the exposed surface of the petri dish with a gloved finger after neutralizing the surface with a Zerostat anti-static pistol (Sigma-Aldrich).

Water is a strong dielectric with a relative permittivity of 78.5, and can be easily polarized in the presence of an electric field. As seen in FIG. 5, when a water droplet (e.g., the one or more droplets (140)) encounters the electric field produced by the static charges (114), then, as shown in the inset in FIG. 5, they get polarized. The polarization of the water drops has two consequences: it attracts the drops toward the charge resulting in the drops moving to the location on the interface directly above the charge, and it leads to dipole-dipole repulsion between the drops. The combination of these two effects result in a preferential self-assembly of the drops at the interface above the location of the static charges.

FIGS. 6A-6E shows the patterns formed by N number of drops as they assemble above the exposed window on the petri dish. Note that the dotted circle in the N=2 image represents the outline of the exposed window. The reason for covering most of the petri dish with aluminum foil and only exposing a small window is to localize the effect and to eliminate unwanted field interactions. As shown in the figure, the drops show 2D crystalline order from N=2 to N=6. Adding more drops to this simply experiment resulted in a breakdown of this order and coalescence between some of the drops. This breakdown could be because the attractive force bringing the drops toward the charge is stronger than the dipole-dipole repulsion between the drops.

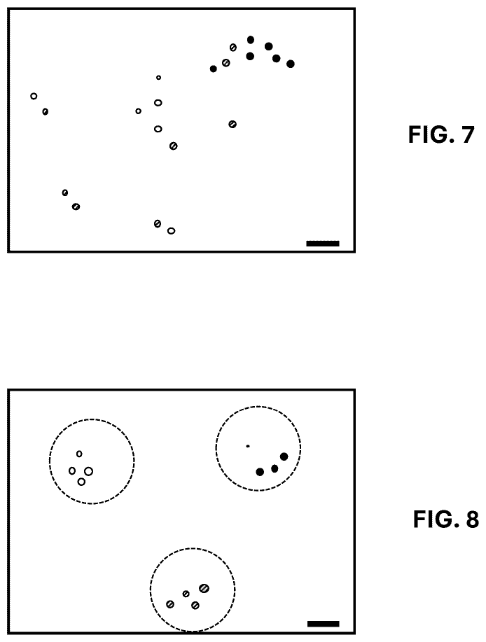

FIG. 7 shows the “unorganized” state of the drops (in these examples, droplets were dyed red, blue, or green) when the petri dish below is fully exposed. The randomly distributed static charges on the surface leads to a random distribution

of the drops along the interface. To achieve a more “organized” pattern—one where the location of the drops can be dictated—the petri dish is covered with aluminum foil only exposing three circular areas as shown in FIG. 8. Each colored drops were released above its corresponding window. Thus, one is able to sort and organize the three different colored drops into three different regions. Patterning the surface of the container with static charges is therefore a simple way to dictate the location of the uncharged floating drops and to create local self-assembled colonies.

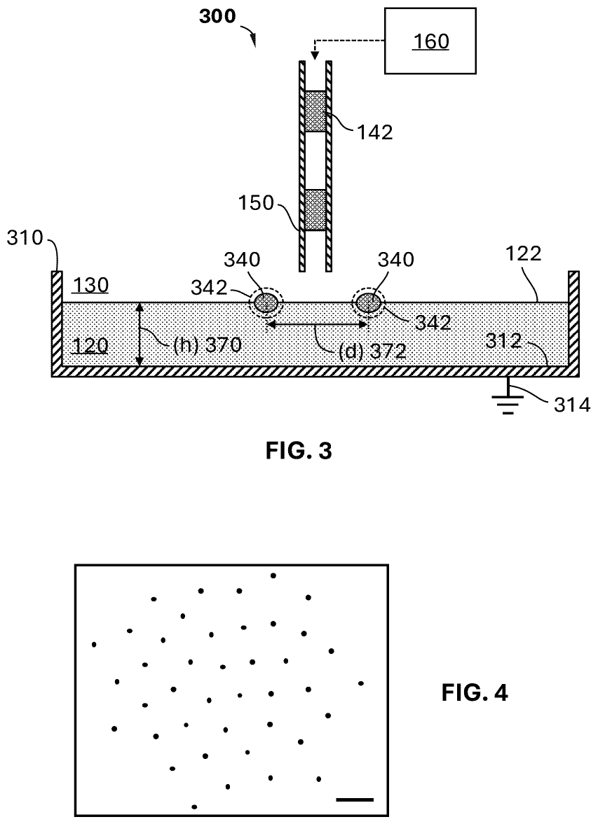

In a second configuration, the droplet may be electrically charged and the container may be a grounded, conductive container. This can be seen in FIG. 3, where the droplets (340) have an electric charge (342), and the container (310) is a conductive container that is grounded (314).

### Example 2

Example 2 uses the second configuration. This example uses the same anhydrous composition and aqueous composition used in Example 1. In this second configuration, the drops are electrically charged and are dispensed onto a petri dish covered with aluminum foil and electrically grounded, as shown in FIG. 3. The drops are generated with a microfluidic T-junction device, and they flow through a TEFLON® polytetrafluoroethylene (PTFE) tube (length L=20 cm and inner diameter 0.38 mm), where they pick up a net positive charge due to the charge separation that happens at the electrical double layer. Note that the flow of water coming into the container is not continuous but rather discrete, with the oil phase separating two water drops. The discrete flow of water allows the drops to pick up more charge and is the underlying reason for using a microfluidic drop generator. FIG. 4 shows the self-assembly of the charged drops which exhibit more order than the polarized case.

Referring again to FIG. 3, in each of the two configurations, the upper surface (122) of the anhydrous composition (120) may be a distance h (370) from the bottom internal surface (312) of the container. In various embodiments, h may be no more than 10 cm, 9 cm, 8 cm, 7 cm, 6 cm, or 5 cm. In preferred embodiments, h may be no more than 4 cm. In more preferred embodiments, h may be no more than 3 cm. In even more preferred embodiments, h may be no more than 2 cm. In still more preferred embodiments, h may be no more than 1.5 cm. In yet more preferred embodiments, h may be no more than 1.25 cm. In some embodiments, h may be no more than 1.1 cm. In some embodiments, h may be no more than 1 cm. In some embodiments, h may be at least 1 mm. In some embodiments, h may be at least 2.5 mm.

The droplets may be, independently, separated by a distance d (372) (measured center-to-center of the droplets). In some embodiments, d may be at least 0.1 mm. In various embodiments, d may be no more than 10 cm, 9 cm, 8 cm, 7 cm, or 6 cm. In preferred embodiments, d may be no more than 5 cm.

In some aspects, the droplet(s) may include multiple droplets (such as four or more droplets), and an average distance (d) between each droplet and surrounding droplets (such as the at least three closest droplets, if there are four or more total droplets) may be configured to be controlled by adjusting an average depth (h) of the anhydrous composition within the container.

In some examples, electrically charged drops are dispensed onto the center of the container with the oil bath of some height h. The drops have a radius of about R=1.5 mm and have a charge of approximately Q_{d}=0.05 nC as measured using a Faraday cup. As subsequent drops are added, the previous drops get pushed away from the center towards the edges due to electrostatic repulsion and due to the flow of oil in the bath. Therefore, in order to ensure that all experiments start at a similar initial condition and that the patterns being observed are independent of the dynamics that occur during the introduction of these drops, the dispensed drops were brought closer together at the interface and were constrict using a dielectric stylus, upon stopping the drop dispensation, before allowing them to spread apart and relax.

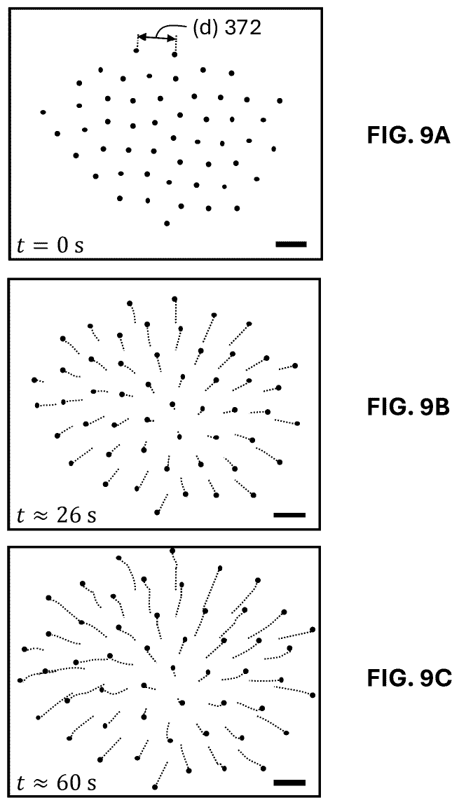

FIGS. 9A-9C shows an image sequence for a case with h=0.4 cm at the moment they were allowed to relax (which is labelled t=0), at t≈26 s, and at t≈60 s. The dotted line tails map out the trajectory of each drop from its initial position. Note that the length of the tails is indicative of the speed of the drops, which is higher for the drops along the periphery. In what follows, it will be shown that this system is dominated by electrostatic repulsion. The drops are always moving away from each other although they will reach a quasi-equilibrium configuration within the observation time in the experiments.

It should be noted that in many cases (such as with an empty petri dish), the bottom internal surface of the container may be flat. In such cases, a depth of the anhydrous composition (e.g., the distance h in FIG. 3) in the container may be substantially constant for across bottom surface of the container. However, in some embodiments, the bottom internal surface of the container may be contoured (see, e.g., FIGS. 19 and 21), such that a depth of the anhydrous composition at a first location within the container may be less than a depth of the anhydrous composition at a second location within the container. As will be understood, depending on the exact shape of the bottom surface of the container, the resulting depths of the anhydrous composition may change in various ways. For example, there may be one or more gradual or continuous changes across the bottom of the container (see the hemispherical bump in FIG. 19, or the inclined plane in FIG. 21), or there may be more of step changes (such as the sharp drop-off after the inclined plane seen in FIG. 21), or some combination thereof.

In some embodiments, the change in depth h may be at least 1 mm, 2 mm, or 3 mm. In some embodiments, the change in depth h may be no more than 1 cm. In some embodiments, the change in depth h may be no more than 75% or 50% of the maximum depth h of the anhydrous composition.

### Effect of the Height of the Oil Bath

For charged droplets, how the distances between the drops evolve as the assemblies reach their quasi-equilibrium patterns was analyzed. The distance d for a given drop may be defined as the average distance to three of its closest neighbors. Three neighbors were chosen since the drops on the outer edge of the pattern might only have three neighbors—two on each side and one towards the interior.

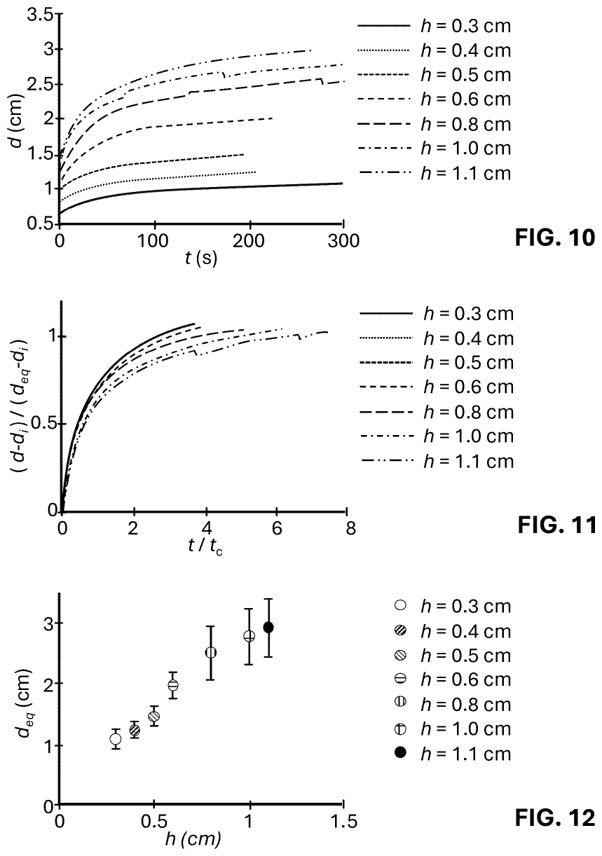

FIG. 10 shows the average distance d, average of \hat{d} for all the drops in the container, as a function of time t, with t=0 being arbitrarily defined as the time when the assemblies were allowed to relax from the initial state of confinement. The magnitude of d increases over time and effectively approaches a constant value, which can be defined as the quasi-equilibrium distance d_{eq}. In FIG. 11 the time evolution of d is rescaled by only considering the fractional change in distance (d−dᵢ)/(d_{eq}−dᵢ) over time, where dᵢ=d|ₜ₌₀. Time is rescaled with an empirical time scale t_{c}=(d_{eq}−dᵢ)/V₀, where

$${V}_{0} = \frac{d}{dt} ( {d}_{i} )$$

is the initial velocity of the drops as calculated from the experimental data. In FIG. 12, d_{eq} is plotted as a function of h. As h is increased, d_{eq} also increases. But for large h, d_{eq} is only weakly dependent on h which is expected since the effect of the bottom boundary will become negligible as the distance from the boundary is increased. The dependence of the collective behavior of the drops on the bath height h is captured by the electrostatic potential φ and can be explained with a simplified model.

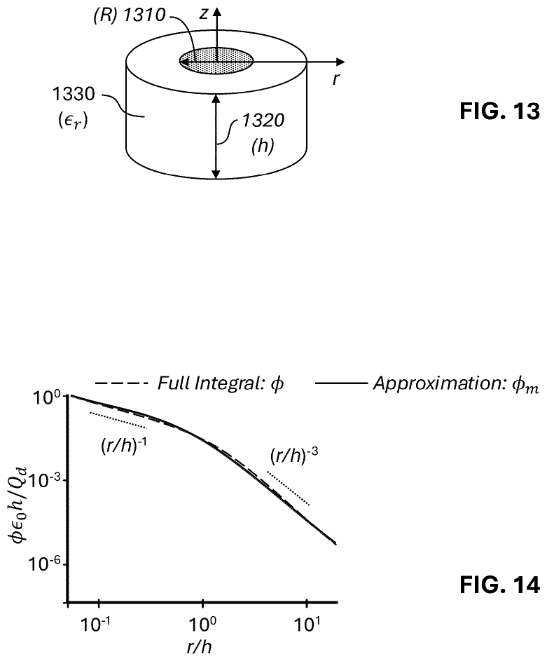

Consider the geometry shown in FIG. 13, where the drop is assumed to be a flat circle of radius R located at the origin with a uniform charge distribution. A domain is considered that is infinite in the radial direction r and semi-infinite in the axial direction z, where there is a finite height h of oil below the drop with a relative permittivity ∈ᵣ and an infinite layer of air above the drop. An exact analytical solution does not exist for φ in closed form. But, the approximate solution, labelled φₘ, representing the electrostatic potential at the interface generated by one drop can be written as

$${ϕ}_{m} ( r , z = 0 ) = \frac{{Q}_{d} {h}^{2}}{2 {πϵ}_{0} r [ ( {ϵ}_{r} + 1 ) {h}^{2} + {ϵ}_{r}^{2} {r}^{2} ]} \qquad ( 1 )$$

where Q_{d} is the total charge of the drop, ∈₀₀=8.854×10⁻¹² F m⁻¹ is the permittivity of free space, and r is the distance from the center of the drop.

The model captures the dielectric discontinuity at the oil-air interface and the conductive boundary condition at the bottom. FIG. 14 shows ϕₘ plotted along with the exact numerical solution ϕ in the point charge limit (R→0), evaluated at z=0, in dimensionless form. Note that for shallow bath heights, corresponding to large r/h, the dimensionless potential scales as (r/h)³ which means that the potential has a quadratic dependence with the height, as also seen from eqn (1).

It is important to note that the patterns observed in FIGS. 9A-9C and the separation distances [symbol] _{f} that are measured are mesoscale, with [symbol] _{f}>>l_{c}, which clearly indicates that the electrostatic interactions are much stronger than the Cheerios effect (see, e.g., FIG. 16).

The velocity of drops spreading is analyzed as a function of time and is compared with the theoretical prediction using the calculated electrostatic potential in order to validate that the system is dominated by electrostatic repulsion. Assuming that inertia is negligible, the evolution of the speed of a single drop for a purely repulsive system can be derived by balancing the viscous drag force with the electrostatic force. In the experiments, the Reynolds number Re=ρ₀VR/μ₀, where V is the speed of the drops, ranges from 0.007 to 0.7, with the maximum corresponding to the early time dynamics of the experiments with the largest bath height. Taking the viscous drag to be that of a sphere in a bulk fluid modified by a fitting parameter β, which accounts for any excess drag due to the presence of the interface and the bottom surface of the container in shallow cases, the velocity is

$$V = \frac{1}{6 β π {μ}_{0} R} \frac{{dU}_{e}}{dr} {\hat{e}}_{r} .$$

Here Uₑ=Q_{d}ϕₘ(r, z=0) is the electrostatic energy and êᵣ is the unit vector from the drop towards its neighbor. The theoretical velocity of a two-body system separated by a distance r is then

$$V = \frac{{Q}_{d}^{2} {h}^{2} [ ( {ϵ}_{r} + 1 ) {h}^{2} + 3 {ϵ}_{r}^{2} {r}^{2} ]}{12 β {π}^{2} {μ}_{0} {{Rr}^{2} [ ( {ϵ}_{r} + 1 ) {h}^{2} + {ϵ}_{r}^{2} {r}^{2} ]}^{2}} {ê}_{r} \qquad ( 2 )$$

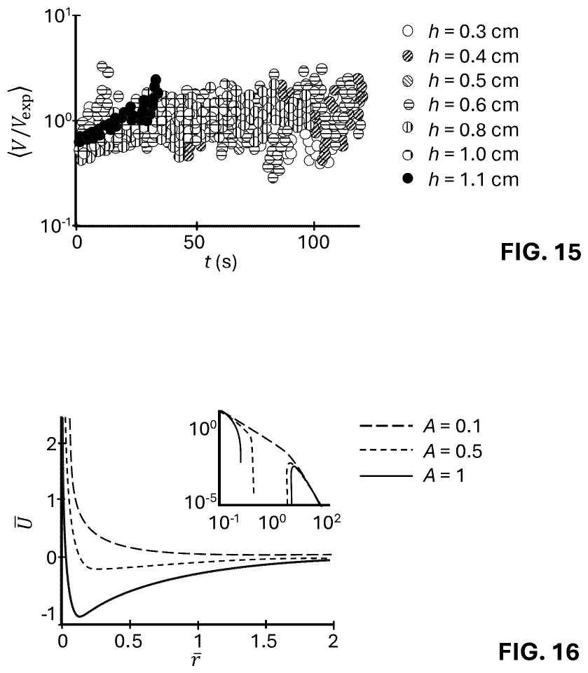

The theoretical velocity of each of the drops in the container may be calculated at every time step by taking the distances and unit vectors as input from the experimental data and summing the two-body interactions between a drop and six of its closest neighbors to calculate the resultant velocity vector. Considering more than six neighbors had negligible effect on the resultant velocity vector. The magnitude V of this theoretical velocity in the absence of any fitting, i.e. taking the fitting parameter β to be 1, can be compared to the magnitude of the experimentally measured velocity Vₑₓₚ for each drop in the container. The ratio of the two velocities averaged over all the drops for a given time step, [symbol] V|_{β=1}/Vₑₓₚ [symbol] , is nearly time-independent, indicating that the model captures the spatiotemporal variations in the drop velocities well. Using the fitting parameter, β, one can further collapse [symbol] V/Vₑₓₚ [symbol] around unity, as shown in FIG. 15. suggesting that the model with one fitting parameter β captures the major experimental features. The scatter in the data may be attributed to the point charge approximation of the drop in the model and the nonlinear many-body interactions not considered in the model. Nevertheless, the reasonable agreement between the experimental data and the model prediction suggests that the dynamics are dominated by electrostatic repulsion.

The time that it would take for two drops starting at the center of the container to repel and reach the side walls of the container was also calculated. The distance from the center to the side walls of the container is approximately l=7.5 cm for the smallest container used in these example embodiments. The time t_{f} that it would take the drops to traverse that distance can be calculated by t_{f}=∫₀^{l}(1/V)dr which is about 3 hours and 40 hours for h=1.1 cm and h=0.3 cm, respectively. These large durations are a result of the quickly decaying strength of the electrostatic potential, which scales as r⁻³, and is also the reason why the distance between the drops appears to approach a quasi-equilibrium value.

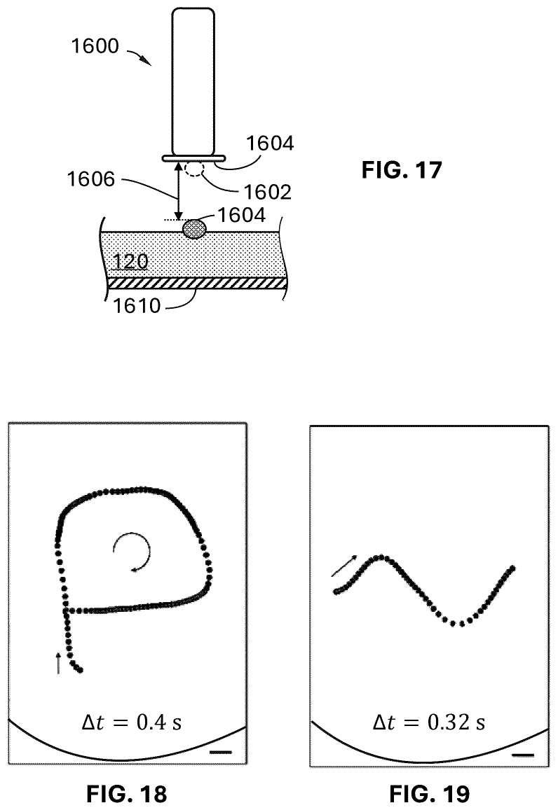

Additionally, the system may include a stylus having an electrostatic charge on at least one surface. An example of this is seen in FIG. 17, where the stylus (1600) with an electrostatic charge (1602) on an external surface (1604) is shown positioned above the anhydrous composition and a droplet (1640). The at least one surface (e.g., external surface (1604)) may be configured to polarize the droplet (1640) while being disposed a distance (1606) from the droplet. The at least one surface may be configured to allow the droplet to be repositioned when the stylus is moved parallel to the oil-air interface. The stylus may be configured to be held above the oil-air interface when moving parallel to the oil-air interface.

As disclosed herein, static charges present on the surface of the container, which is underneath the drops, can affect the position of the drops at the oil-air interface. A more dynamic yet simple approach using a dielectric stylus may be utilized, as shown schematically in FIG. 17.

In one example, the plunger of a syringe was used a dielectric stylus and charges on its bottom flat surface were placed through contact electrification, after neutralizing the surface with a Zerostat anti-static pistol.

The stylus could then be used to move the drop as needed on the interface. In FIGS. 18 and 19, images are provided that show the spatiotemporal evolution of a drop as the stylus is used to draw the letter “P” and to draw a sine wave. Since the electrostatic interactions are instantaneous and the friction is low due to the low viscosity of the oil phase, the drops can be manipulated rather quickly. This is a revolutionary method for manipulating dielectric drops at an interface, due to its simplicity and effectiveness.

While a stylus may be used, one can also use passive control via a prescribed shape of the container to control droplets. As disclosed herein, the height of the oil bath h affects the distance d between the drops, with d increasing as h is increased. However, it was found that when the bottom conductive surface is non-uniform, it leads to something more than just a non-homogeneous pattern of the drops. A non-uniform height of the oil bath creates an energy landscape with the lowest energy state being directly above the shallowest point. Therefore, the drops will preferentially assemble at the interface mapping out the shallow areas of the container.

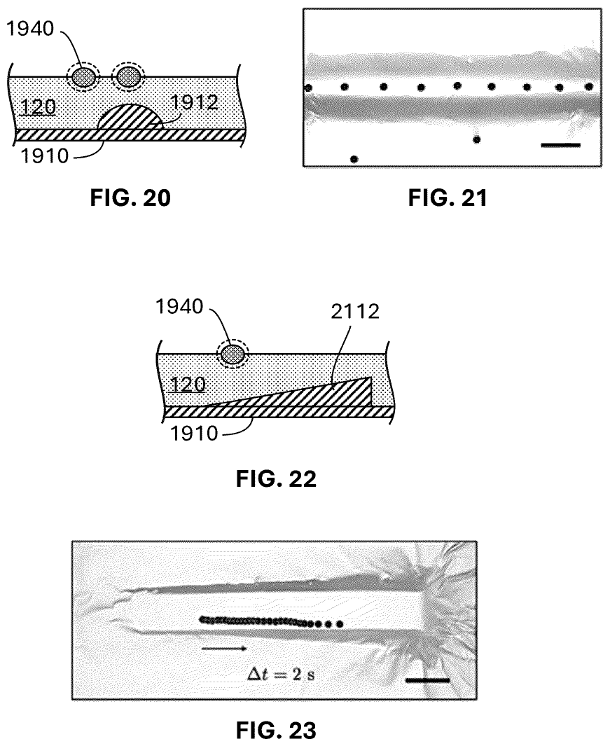

This property of the system can be used to pattern the self-assembled shapes. FIG. 20 shows a schematic of an experimental system, where a horizontal section of a cylinder was used to create the uneven bottom surface. FIG. 21 shows the experimental image at a quasi-equilibrium state, where the drops have moved and arranged themselves along the shallow ridge over the elevated surface.

The underlying physics that drives the drops to the shallow region can be explained by the classic problem in electrostatics of a point charge next to a conducting sphere.

Although the ideas remain the same, we will consider a hemispherical boss shape rather than the simple sphere, since it is closer to the geometry in the experimental system. If a point charge is confined to a height of h above the conducting surface of the hemispherical boss, the point at which the force along the x direction vanishes is at x=0, directly above the shallow point. This is simply due to the attractive force between the point charge and the conductor that would bring the charge as close to the conductor as possible.

This feature that the charged drop will move along the interface to be close the conducting bottom surface can be further leveraged to create unmediated motion of the drops along a desired path. In experiments, a charged drop was placed above an inclined plane, as schematically shown in FIG. 22, with an inclination angle of about 2°. The drop spontaneously moved toward the shallow end. FIG. 23 shows a spatiotemporal plot showing the trajectory of the drop where the time between each frame shown is 2 s. Although the motion of the drop here is slightly slower compared to the case with the dielectric stylus, this is a simple way to produce unmediated and spontaneous motion at the interface.

As will be understood, a kit comprising two or more of the components disclosed herein may be provided. For example, the kit may include a container and a dispensing nozzle. Different configurations of the containers and dispensing nozzles may be utilized. In a first configuration, the container may be an insulated container, and the dispensing nozzle may be a conductive dispensing nozzle. In a second configuration, the container may be a grounded, conductive container and the dispensing nozzle may be an insulated dispensing nozzle. In certain aspects, a bottom internal surface of the container may be flat, or may be contoured such that an internal volume of the container has at least a first portion with a smaller depth than a second portion.

The kit may include a stylus capable of having an electrostatic charge on at least one surface. That surface may be configured to polarize the droplet while being disposed a distance from the droplet, and may allow the droplet to be repositioned when the stylus is moved parallel to the oil-air interface.

In various aspects, a method for controlling droplets at an oil-gas interface may be provided. The method may include providing either (i) neutrally charged aqueous droplets at the oil-air interface within an insulated container, or (ii) electrically charged aqueous droplets at the oil-air interface with a grounded, conductive container. The method may include controlling droplets without contacting the droplets using at least one technique. A first technique for contactless control may be to actively repositioning droplets by moving a stylus having an electrostatic charge on at least one surface over the oil-air interface to polarize the droplet and allowing the droplet, after being polarized, to be repositioned as the stylus moves. A second technique for contactless control may be passively repositioning droplets by allowing electrically charged aqueous droplets to interact with a contoured bottom internal surface of the grounded, conductive container, to preferentially move towards a location having a smaller distance between the bottom internal surface and the oil-air interface. In some instances, a combination of these two techniques may be used.

Additional objects, advantages, and novel features of the present disclosure will be set forth in part in the description which follows, and in part will become apparent to those skilled in the art upon examination of the following or may be learned by practice of the systems, methods, and apparatus described herein.

Although various embodiments which incorporate the teachings of the present disclosure have been shown and described in detail herein, those skilled in the art can readily devise many other varied embodiments that still incorporate these teachings. Thus, while the foregoing is directed to various embodiments of the present disclosure, other and further embodiments may be devised without departing from the basic scope thereof. As such, the appropriate scope of the present disclosure is determined according to the claims.

What is claimed is:

1. A system, comprising:
a container;
an anhydrous composition comprising an oil disposed within the container, such that a surface of the anhydrous composition is exposed to a gas to form an oil-gas interface, and a bottom internal surface of the container is in contact with the anhydrous composition; and
a droplet at the oil-gas interface, the droplet comprising an aqueous composition;
wherein either (i) the droplet is neutrally charged and the container is an insulated container, or (ii) the droplet is electrically charged and the container is a grounded, conductive container.

2. The system of claim 1, wherein the droplet comprises four or more droplets, and an average distance between each droplet and its three closest droplets is configured to be controlled by adjusting an average depth of the anhydrous composition within the container.

3. The system of claim 1, wherein the bottom internal surface of the container is flat, such that a depth of the anhydrous composition in the container is substantially constant.

4. The system of claim 1, wherein the bottom internal surface of the container is contoured, such that a depth of the anhydrous composition at a first location within the container is less than a depth of the anhydrous composition at a second location within the container.

5. The system of claim 1, further comprising a stylus having an electrostatic charge on at least one surface, the at least one surface configured to polarize the droplet while being disposed a distance from the droplet, and allow the droplet to be repositioned with the stylus is moved parallel to the oil-gas interface.

6. The system of claim 5, wherein the stylus is configured to be held above the oil-gas interface when moving parallel to the oil-gas interface.

7. The system of claim 1, wherein the oil comprises a plurality of oils.

8. The system of claim 1, wherein the anhydrous composition is a non-conductive fluid.

9. The system of claim 1, wherein the anhydrous composition and/or the aqueous composition comprises a surfactant.

10. The system of claim 1, wherein the anhydrous composition and the aqueous composition are free of surfactants.

11. A kit, comprising:
a container; and
a dispensing nozzle;
wherein either (i) the container is an insulated container and the dispensing nozzle is a conductive dispensing nozzle, or (ii) the container is a grounded, conductive container and the dispensing nozzle is an insulated dispensing nozzle.

12. The kit of claim 11, wherein a bottom internal surface of the container is flat.

13. The kit of claim 11, wherein a bottom internal surface of the container is contoured, having at least a first portion with a smaller depth than a second portion.

14. The kit of claim 11, further comprising a stylus capable of having an electrostatic charge on at least one surface, the at least one surface configured to polarize a droplet while being disposed a distance from the droplet, and allow the droplet to be repositioned when the stylus is moved parallel to an oil-gas interface.

15. A method for controlling droplets at an oil-gas interface, comprising:
providing either (i) neutrally charged aqueous droplets at the oil-gas interface within an insulated container, or (ii) electrically charged aqueous droplets at the oil-gas interface with a grounded, conductive container; and
controlling droplets without contacting the droplets, where the droplets are the neutrally charged aqueous droplets or the electrically charged aqueous droplets, by:
actively repositioning droplets by moving a stylus having an electrostatic charge on at least one surface over the oil-gas interface to polarize the droplet and allowing the droplet, after being polarized, to be repositioned as the stylus moves;
passively repositioning droplets by allowing electrically charged aqueous droplets to interact with a contoured bottom internal surface of the grounded, conductive container, to preferentially move towards a location having a smaller distance between the bottom internal surface and the oil-gas interface; or
a combination thereof.
